(19) United States
(12) Patent Application Publication
(10) Pub. No.: US 2012/0075451 A1
(43) Pub. Date: Mar. 29, 2012

(54) MULTIMODE OPTICAL DEVICE AND ASSOCIATED METHODS

(75) Inventor: Jeffrey M. RAYNOR, Edinburgh (GB)

(73) Assignee: STMicroelectronics (Research & Development) Limited, Marlow-Buckinghamshire (GB)

(21) Appl. No.: 13/224,733

(22) Filed: Sep. 2, 2011

(30) Foreign Application Priority Data
Sep. 28, 2010 (GB) 1016283.2

(51) Int. Cl. H04N 7/18

(52) U.S. Cl. 348/77; 348/E07.085

(57) ABSTRACT

An optical device for use in an apparatus wherein the optical device is configured for use in a navigation mode and a fingerprint detection mode. By having the capability to operate in two modes, the optical device provides a cost effective approach for navigation and security. Using the same sensor for both functions reduces cost and space requirements, while satisfying functional objectives.

### FIELD OF THE INVENTION

The present invention relates to an optical device, particularly an optical device which can operate in multiple modes.

### BACKGROUND OF THE INVENTION

Mobile phones are a common piece of equipment and are increasingly being used for identification in business transactions. However, they are vulnerable to theft, allowing for easy impersonation. Mobile phones include security systems such as passwords and PIN numbers to lock or access the phone itself or certain applications on the phone. Most of the commonly used security techniques and systems are often easily overcome. For example, passwords and PIN numbers can be accessed by so called “shoulder-surfing”. Criminals use optical devices to watch users making transactions and then gain access to account details, passwords, PIN numbers, etc. Alternatively in crowded places, criminals literally look over the shoulder of a user to determine certain information.

The use of biometrics to provide security has long been seen as a possible answer. In particular, the use of fingerprints is seen as an attractive option. However, most existing fingerprint sensors are large, often as large as or larger than a finger. As such these fingerprint sensors are not very practical for use on a mobile phone or equivalent device.

Attempts have been made to find ways of implementing a fingerprint sensor into a mobile phone or the like. Two Dimensional (2D) “Touchchips” are one such device. However, these are large and touch sensitive to mechanical pressure causing them to break easily.

One-dimensional capacitive sensors offer a smaller alternative proposal and are used in high-end laptops. The user “swipes” a finger over the sensor to be sensed. As these sensors are capacitive, they are still vulnerable to mechanical damage, but fortunately when used in laptops the sensors are protected when the lid is closed. However, they would be unsuitable for mobile phones and the like.

2D optical sensors offer another proposal and are smaller than a finger and generally relatively inexpensive. 2D optical sensors are non-contact and so tend to be more resilient. There are various examples of this technology on the market that could be used for securing mobile phones. The devices typically have VGA (640×480) resolution to capture a whole finger at a resolution sufficient to detect fingerprint details. However, these devices are single function and can only operate as a fingerprint detector. As such this type of sensor would be unsuitable for use as a mouse as the large number of pixels makes computation of motion very difficult and requires a large amount of processing, memory, and silicon real-estate which adds cost and space.

EP06252702.3 discloses a panoramic camera which uses a mouse sensor to sense motion and combine and control images from a separate image sensor for a high-resolution picture.

### SUMMARY OF THE INVENTION

It is an object of the present invention to overcome at least some of the problems associated with the prior art. It is a further object of the present invention to provide a relatively small, inexpensive, low-powered biometric detector that can be used in mobile phones or other devices.

According to one aspect there is provided an optical device for use in a device wherein the optical device is adapted or configured for use in a navigation mode and a fingerprint detection mode.

Optionally, the optical element includes an imaging element which can detect the presence and/or movement of a finger in proximity therewith and further includes an illumination source adapted to be reflected by the imaging element or a finger in proximity therewith to a sensor.

Optionally, the imaging element comprises a frustrated total internal reflection surface and the sensor comprises an array of pixels arranged in rows and columns.

The optical device may further include a frame store for storing images in the fingerprint detection mode and a motion detector which is able to detect movement between successive stored images, to enable a fingerprint image to be built.

Optionally, the fingerprint image is built up by stitching successive images based on the relative position of one image to the next, and based on a motion vector between each successive image. The motion vector between each successive image may be detected on a pixel by pixel basis or an image by image basis.

Optionally, a fingerprint edge is detected where the number of fingerprint features in an image falls below a predetermined value.

Optionally, the optical device can switch from navigation mode to fingerprint detection in response to a switching signal from the device.

According to another aspect there is provided a device including the sensor of the first aspect. The device may be a telephone, a computer, a biometric sensor or any other appropriate device.

According to a further aspect there is provided a method of operating an optical device in a first navigation mode and a second fingerprint detection mode and switching therebetween based on a signal from a device.

The present embodiments offer a number of benefits. By having the capability to operate in two modes; a fingermouse or navigation mode and a fingerprint detection mode, the present embodiments provide a cost effective approach for navigation and security. Using the same sensor for both functions reduces cost and space requirements, while satisfying functional objectives.

The present embodiments can be implemented on any type of device and require only one very small sensor that can be as small as millimeters across. This sensor can be placed in any appropriate location including phones, computers, cash dispensers, checkouts in shops, gates, doors and other entrances/exits or any other appropriate location.

### BRIEF DESCRIPTION OF THE DRAWINGS

Reference will now be made, by way of example, to the accompanying drawings, in which:

FIG. 1 is a diagram of an optical navigation device, in accordance with an embodiment of the invention;

FIG. 2 is a schematic diagram of an optical navigation device processing circuit, in accordance with an embodiment of the invention;

FIG. 3 is a diagram of a fingerprint with a field of view of an optical mouse shown thereon, in accordance with an embodiment of the invention;

FIG. 4 is a diagram of the field of view image from the FIG. 3 field of view, in accordance with an embodiment of the invention;

FIG. 5 is a diagram showing a fingerprint with two fields of view, in accordance with an embodiment of the invention; and

FIG. 6 is a diagram showing a fingerprint and a motion vector, in accordance with an embodiment of the invention.

FIG. 7 is a diagram showing certain image processing steps, in accordance with an embodiment of the invention.

FIG. 8 is a diagram showing an extension of FIG. 7 for multiple images, in accordance with an embodiment of the invention.

FIG. 9 is a diagram showing a finger outside the sensor field of view, in accordance with an embodiment of the invention.

FIG. 10 is a diagram showing the edge of a fingerprint, in accordance with an embodiment of the invention.

FIG. 11 is a diagram showing a more detailed representation of a fingerprint, built up by multiple images, in accordance with an embodiment of the invention.

FIG. 12 is a diagram for showing a “complete” fingerprint scan, in accordance with an embodiment of the invention.

### DETAILED DESCRIPTION OF THE PREFERRED EMBODIMENTS

Mobile telephones and other devices can be provided with touch pads or the optical navigation devices which translate the motion of a finger over the pad into motion of a cursor on screen. One type of touch pad is an optical touch pad, known colloquially as a fingermouse. An optical touch pad functions in a fashion similar to an optical computer mouse. An illumination device or means is provided that illuminates an underside surface of the touch pad. An image sensor is also provided to detect light reflected from the underside of the touch pad. As a finger is moved over the touch pad, image analysis is carried out to detect motion and translate that to movement of a cursor or a pointer on the display screen of the mobile device. The image analysis could detect the relative position of a finger as it moves across the pad, or it could detect the relative position of ridges of skin of the finger as it moves. In addition, in the present embodiments the sensor can be used to detect fingerprints for security or other reasons, as will be described below.

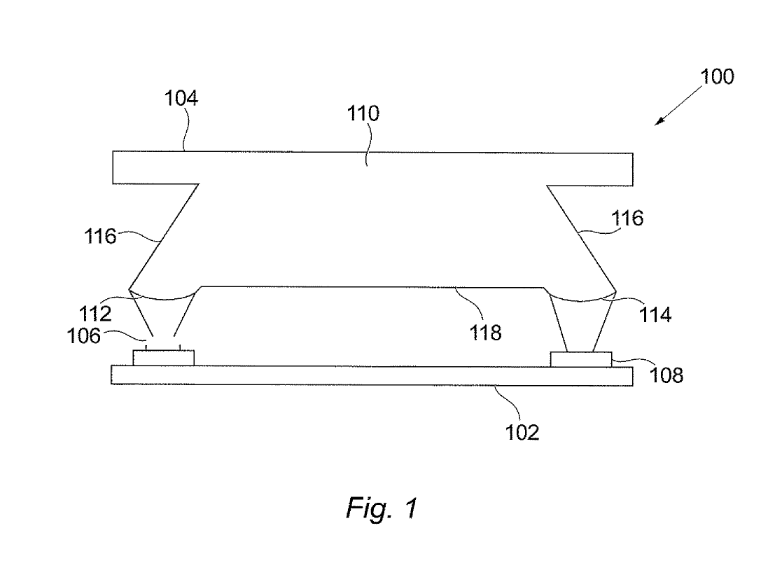

FIG. 1 is a representation of an optical navigation device, such as a fingermouse 100. The fingermouse includes a base 102; an imaging element shown generally at 104; an LED 106 and a sensor 108. The top surface 110 of the imaging element 104 is a frustrated total internal reflection (FTIR) surface. In addition, the imaging element includes a collimating lens 112 between the LED and the imaging element and an imaging lens 114 between the imaging element and the sensor. The imaging element further includes two total internal reflection mirror elements 116 which direct illumination from the collimating lens to the frustrated total internal reflection surface and then from the frustrated total internal reflection surface to the imaging lens. The lower surface 118 of the imaging element is substantially flat. This is just one example of a fingermouse there may be many other forms or types. The illumination of the imaging element by the source can be used for detecting finger movement for determining mouse commands and for detecting a fingerprint for security and other related purposes. The imaging element may not be an FTIR surface, but any other appropriate surface. If this is the case any reflection may be effected by the finger in proximity with the imaging element rather than the FTIR surface.

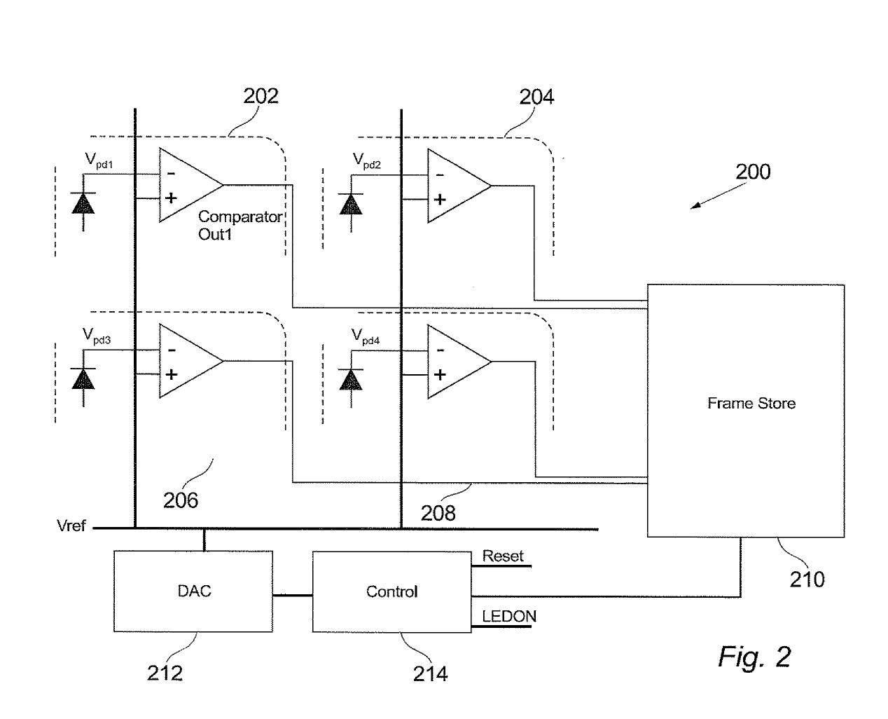

An image of any detected movement or fingerprint is captured at the sensor 108. The sensor is typically an array of pixels arranged in rows and columns, each pixel having associated therewith a processing circuit as is described with reference to FIG. 2.

Referring to FIG. 2 a block diagram of a processing circuit 200 is shown. For clarity of illustration, the diagram shows four amplifier and photo-diode arrangements 202, 204, 206 and 208 although it will be appreciated that in fact a typical array will have more pixels than this. For example, a real array may have 18×18; 20×20; 25×25 or 30×30 pixels, and perhaps an even higher numbers of pixels. The circuit also includes a frame store module 210, a digital to analog converter 212 and control circuitry 214. This circuit deals with a single pixel. However, to avoid the problems of pixel-pixel mismatch and any thermally induced noise the output from individual pixels may be combined in any appropriate manner. For example, an appropriate manner may include averaging, summing or summing and truncating the data.

As previously indicated the present embodiments relate to using the fingermouse on a device and incorporating the detection and analysis of a fingerprint to enable biometric security operations. An optical mouse sensor usually discards any images after motion has been detected and used to determine a control action.

The present embodiments include a further frame store (large enough to store the features of a fingerprint) and adds image data to the frame store after each image is detected. As the user moves their finger over the surface, the navigation engine on the mouse detects the motion (as normal) and then uses this to add the current image to an accumulated image to generate an overall image of a fingerprint.

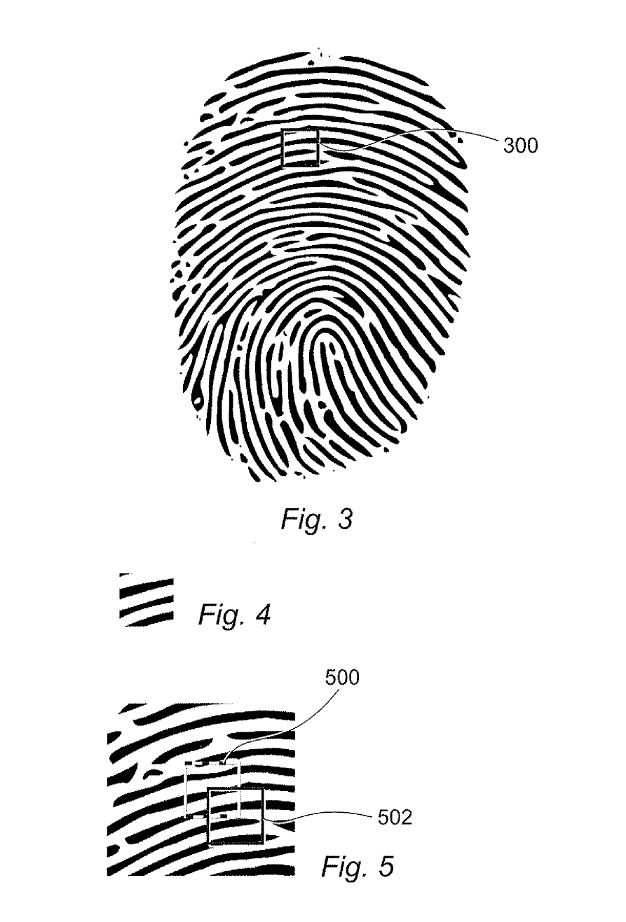

FIG. 3 shows a representation of a fingerprint, with a mouse field of view indicated at 300. Clearly the field of view is much smaller than the fingerprint due to the small size of the imaging element on the fingermouse. From a security point of view to detect from just one field of view of a fingerprint would not be sufficient to identify a person from other people. A certain minimum number of features must be detected and matched in order for a fingerprint to be validated. Different levels of security may require a different number of features to be validated. FIG. 4 shows a portion of the fingerprint as captured in FIG. 3 which is then stored in the further frame store as part of an image map.

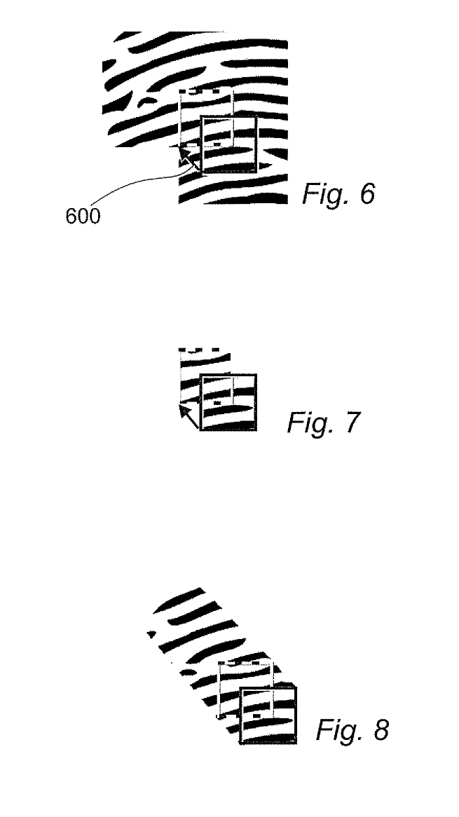

In FIG. 5 a section of the fingerprint is shown with two overlapping fields of view 500 and 502. In FIG. 6 a motion vector 600 is shown to illustrate the movement between the first image field of view 500 and the second image field of view 502. FIG. 7 shows a large (half frame) motion vector between the two fields of view 500 and 502. It should be noted that this motion vector would typically be smaller than shown in reality, on the order of the scale of one pixel. As the finger continues to move over the surface of the imaging element more and more images of different fields of view are captured and saved in the further frame store. The first part of a captured and saved fingerprint is shown in FIG. 8.

The manner in which the images are stitched together will now be described. At a first time at the beginning of operation it is assumed that there is no finger on the sensor and that the frame store for the fingerprint is initialized to a value to indicate that “no data is available” (e.g. 0x00 or 0xFF). The initialization value is not essential but preferred. The system also contains a two dimensional pointer (XP, YP) for the X and Y directions respectively, which points to the fingerprint frame store in a corresponding position on the area of the finger which is detected by the sensor. In one embodiment the initial position of the pointer is the center (X & Y) of the fingerprint framestore.

The user then places a finger on the sensor which is detected by the system and the image is placed in the fingerprint framestore. This is the region indicated by the 2D pointer (currently at center of fingerprint framestore). The image data from the sensor then replaces the values in the fingerprint framestore which had previously indicated that “no data is present”. This position is shown in FIG. 4.

The user then moves their finger. This motion is monitored by a motion engine which is a module within the optical mouse. From this point there are various options, including single pixel motion vector determination and multi-pixel motion vector determination.

In single pixel motion vector detection (pixel by pixel) the motion engine detects the finger has moved 1 pixel (e.g. to the left), and there is now a new fingerprint image at the left column of the sensor. This column of data is written into the fingerprint framestore using the 2D pointer. If the pointer is pointing to the center of the image, then the data *column* to be stored is:

(XP×0.5)×image sensor size X,YP)

This position is shown in FIG. 7.

In multi-pixel motion vector detection (image by image) the system may wait until the motion engine has detected that the finger has moved 1 image. The new image of the fingerprint is then stored in the fingerprint framestore using the 2D pointer at:

(XP+motion_vectorX,YP+motion_vectorY).

The fingerprint has an edge which is basically defined as the area of the finger which never comes in contact with the imaging element of the fingermouse. In normal use the area of the finger that comes in contact with fingermouse will be the ball of the finger and the “edge” of the fingerprint is that part which does not come into contact with the sensor. The edge of the fingerprint can be identified by detecting the number of “fingerprint” features that are detected in a given field of view. At the edge of the fingerprint the number of features will be lower than in the area of the ball of the finger. When the number of features of the image has dropped below a predetermined threshold, there is presumed to be no finger on the imaging element.

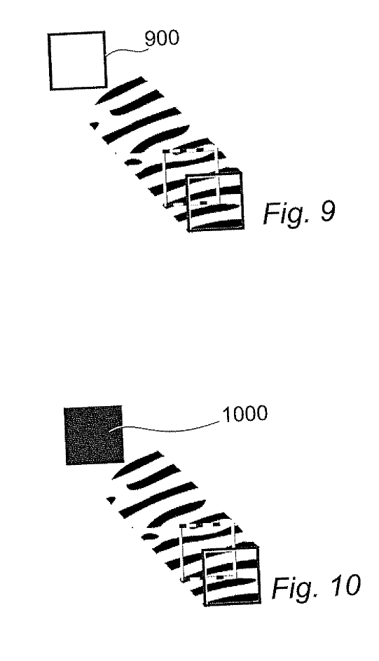

An area with no features detected is shown in FIG. 9 where the field of view 900 is outside the field of view of the sensor. In this case navigation algorithm would detect a number of features lower than a predetermined threshold, thereby identifying an area outside the fingerprint. This information could be encoded into the fingerprint image to record the “edge of fingerprint” information. This may be encoded via: a special value {00 or 0xFF}; a bit in the fingerprint image (least significant bit or ms bit) or use of a separate image store to store edge information. In FIG. 10, this is represented by dark box 1000.

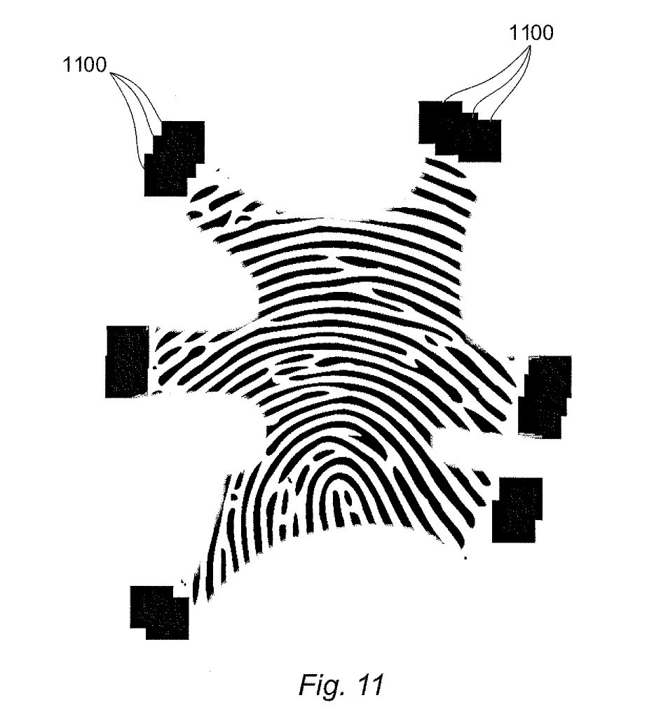

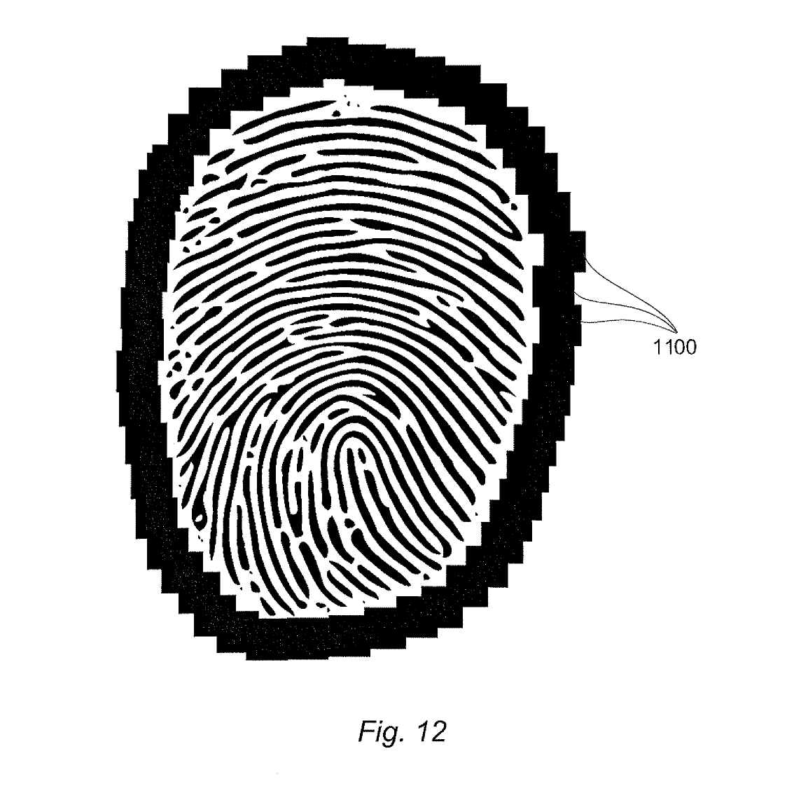

When the system recognizes that the edge of a fingerprint has been reached this information (no fingerprint) is recorded and an assumption is made that a particular part of the finger has been completely scanned. The scanning of the fingerprint fields of view continues and gradually an image of the fingerprint is built up with multiple fields of view and multiple edge areas 1100 as shown in FIG. 11. Once the fingerprint map has detected that all or most of the fingerprint has been scanned a completed fingerprint scan is generated as shown in FIG. 12. The fingerprint map is also referred to as the fingerprint framestore or the further framestore. The framestore map is a memory that the logic circuitry (or algorithm) can use to check if the fingerprint has been entirely (or substantially) scanned. This is particularly the case with the codes which indicate that no image is present.

The completed scan includes all the relevant fields of view detected by the sensor and the edge of the fingerprint in the form of a large number of edge events 1100. The completed image of the fingerprint can then be scanned and transmitted to a processing engine or security system (remote or local) where the fingerprint is validated or authenticated (or not) in a known manner. The validation (or not) is then communicated back to the input device for use as required. If validated, the device may be permitted to carry out one or more secure tasks. Secure tasks may be those which are restricted only to the rightful owner of the device, or may include any other process which incorporates a security step, such as banking or purchasing on line. It will be appreciated that the fingerprint can serve as a way of authenticating a user for any number of purposes, not just those mentioned herein.

One common concern of potential users of fingerprint security systems is that criminals will obtain a copy of the users fingerprint by making a plastic model or even cutting off the finger of a user. The present embodiments provide a further way which can be used to verify only a live finger attached to the user. To differentiate between a finger attached to a living body, and one that has been amputated or a rubber mold of a finger the sensor, is adapted for use with two different wavelengths. The device uses two LEDs with different wavelengths, e.g. 850 nm and 940 nm and then uses images from these wavelengths to determine the level of blood oxygen in the image. This analysis is based on the ratio of changing absorbance of the red and infrared light which occurs in oxygenated blood and deoxygenated blood, due to the color difference thereof. This can then be used to determine the level of oxygenation in the blood.

Preferably, if the images for the two different wavelengths are collected repeatedly, the heart-rate of the user can be determined. This serves as further proof that the user is alive.

The sensor can operate both in a fingermouse mode and in a fingerprint detection mode. The sensor usually operates in a fingermouse mode and can switch to the fingerprint detection mode when this facility is required.

Typically switching between fingermouse mode and fingerprint detection mode is controlled by a host system of the device. The system will normally be in fingermouse mode. When the device wants to authenticate the user, the system would be automatically switched into fingerprint detection mode. For example, this could occur: when turning on the screen after a period of inactivity; if the user wishes to purchase something on the internet; or to authorize a NFC (Near Field Communication) payment system of a mobile phone.

The sensor may be any appropriate type and may be a CMOS sensor having an array of pixels for measuring reflected light at different locations of the imaging element 104 to produce an image thereon. The LED may be of any appropriate type and may generate a source in the “optical” or non-optical ranges. Accordingly, reference to optics and optical are intended to cover wavelengths which are not in the human visible range.

The combined optical navigation device and fingerprint detector may be used in many different environments in an appropriate device, for example: an optical pushbutton; a fingerprint scanner; lab-on-chip devices; bio-optical sensors (e.g. for detecting chemi-fluorescent for medical or biotesting applications); entrances; exits; and phones.

The optical navigation device may be used in any suitable devices such as a mobile or smart telephone, other personal or communications devices, a computer, a camera, a remote controller, access device or any other suitable device.

It will be appreciated that there are many possible variations of elements and techniques which would fall within the scope of the present invention.

1-19. (canceled)

20. An optical device comprising:
an optical sensor; and
processing circuitry associated with the optical sensor and configured to be operated therewith in a navigation mode and a fingerprint detection mode.

21. The optical device of claim 20, further comprising an imaging element configured to detect at least one of a presence and movement of a finger in proximity therewith.

22. The optical device of claim 21, further comprising an illumination source configured to provide light to be reflected by the imaging element or a finger in proximity therewith to the optical sensor.

23. The optical device of claim 22, wherein the imaging element comprises a frustrated total internal reflection surface.

24. The optical device of claim 20, wherein the optical sensor comprises an array of pixels arranged in rows and columns.

25. The optical device of claim 20, wherein the processing circuitry comprises a frame store configured to store images in the fingerprint detection mode.

26. The optical device of claim 25, wherein the processing circuitry comprises a motion detector cooperating with the frame store and configured to detect movement between successive stored images.

27. The optical device of claim 26, wherein the processing circuitry is configured to construct the fingerprint image by combining successive images based on the relative position of one image to the next, and based on a motion vector between each successive image.

28. The optical device of claim 27, wherein the processing circuitry is configured to detect the motion vector between each successive image on a pixel by pixel basis.

29. The optical device of claim 27, wherein the processing circuitry is configured to detect the motion vector between each successive image on an image by image basis.

30. The optical device of claim 27, wherein the processing circuitry is configured to detect a fingerprint edge where a number of fingerprint features in an image falls below a threshold value.

31. The optical device of claim 20, wherein the processing circuitry is configured to be switched from navigation mode to fingerprint detection in response to a switching signal.

32. An apparatus comprising:
optical device including
a sensor, and
processing circuitry associated with the optical sensor and configured to be operated therewith in a navigation mode and a fingerprint detection mode.

33. The apparatus of claim 32, wherein the optical device further comprises an imaging element configured to detect at least one of a presence and movement of a finger in proximity therewith.

34. The apparatus of claim 32, wherein the optical device further comprises an illumination source configured to provide light to be reflected by the imaging element or a finger in proximity therewith to the optical sensor.

35. The apparatus of claim 34, wherein the imaging element comprises a frustrated total internal reflection surface.

36. The apparatus of claim 32, wherein the processing circuitry further comprises a frame store configured to store images in the fingerprint detection mode.

37. The apparatus of claim 36, wherein the processing circuitry further comprises a motion detector cooperating with the frame store and configured to detect movement between successive stored images.

38. The apparatus of claim 37, wherein the processing circuitry is configured to construct the fingerprint image by combining successive images based on the relative position of one image to the next, and based on a motion vector between each successive image.

39. The apparatus of claim 32, wherein the processing circuitry is configured to be switched from navigation mode to fingerprint detection in response to a switching signal.

40. The apparatus of claim 32, wherein the apparatus defines at least one of a wireless communication device and a computer.

41. The apparatus of claim 32, wherein the optical device is configured to communicate with a security system to authenticate any detected fingerprint.

42. A method of operating an optical device comprising an optical sensor, and processing circuitry associated therewith, the method comprising:
operating the optical device in a navigation mode;
operating the optical device in a fingerprint detection mode; and
switching between the navigation and fingerprint detection modes based on a switching signal from a host device.

43. The method of claim 42, further comprising:
detecting the presence of a user fingerprint; and
communicating with a security system to authenticate the fingerprint in association with the host device to allow the user to carry out a secure task on the host device.

44. the method of claim 42, wherein the optical device further comprises an imaging element configured to detect at least one of a presence and movement of a finger in proximity therewith.

45. The method of claim 44, wherein the optical device further comprises an illumination source configured to provide light to be reflected by the imaging element or a finger in proximity therewith to the optical sensor.

46. The method of claim 42, wherein the processing circuitry further comprises a frame store configured to store images in the fingerprint detection mode.

47. The method of claim 46, wherein the processing circuitry further comprises a motion detector cooperating with the framestore and configured to detect movement between successive stored images.

48. The method of claim 47, wherein the fingerprint image is constructed by combining successive images based on the relative position of one image to the next, and based on a motion vector between each successive image.

49. The method of claim 46, wherein a fingerprint edge is detected where a number of fingerprint features in an image falls below a predetermined value.
